(19) United States
(12) Patent Application Publication
(10) Pub. No.: US 2009/0063465 A1
(43) Pub. Date: Mar. 5, 2009

(54) System and method for string processing and searching using a compressed permuterm index

(75) Inventors: Paolo Ferragina, Pisa (IT); Rossano Venturini, Camaiore (Lucca) (IT)

Correspondence Address: Law Office of Robert O. Bolan, P.O. Box 36, Bellevue, WA, 98009, US

(73) Assignee: Yahoo! Inc., Sunnyvale, CA (US)

(21) Appl. No.: 11/897,427

(22) Filed: Aug. 29, 2007

(51) Int. Cl. G06F 17/30

(52) U.S. Cl. 707/5; 707/E17.017

(57) ABSTRACT

An improved system and method for string processing and searching using a compressed permuterm index is provided. To build a compressed permuterm index for a string dictionary, an index builder constructs a unique string from a collection of strings of a dictionary sorted in lexicographic order and then builds a compressed permuterm index to support queries over the unique string. A dictionary query engine supports several types of wild-card queries over the string dictionary by performing a backward search modified with a CyclicLF operation over the compressed permuterm index. These queries may used to implement other queries including a membership query, a prefix query, a suffix query, a prefix-suffix query, a query for an exact or substring match, a rank query, a select query and so forth. String processing and searching tasks may accurately be performed for sophisticated queries in optimal time and compressed space.

### FIELD OF THE INVENTION

The invention relates generally to computer systems, and more particularly to an improved system and method for string processing and searching using a compressed permuterm index.

### BACKGROUND OF THE INVENTION

String processing and searching tasks are at the core of modern web search, information retrieval and data mining applications. Many of these tasks may be implemented by basic algorithmic primitives which involve a large dictionary of strings having variable length. Typical examples of such tasks may include pattern matching (exact, approximate, with wild-cards), the ranking of a string in a sorted dictionary, or the selection of the i-th string from it. In particular, there has been ongoing research to improve existing solutions to the string dictionary problem, also known as the Tolerant Retrieval problem in the research literature, in which pattern queries may possibly include one wild-card symbol.

As strings get longer and longer, and dictionaries of strings get larger and larger, it becomes crucial to devise implementations for such primitives which are fast and work in compressed space. Some classical approaches to the Tolerant Retrieval problem include implementations using tries, front-coded dictionaries, and ZGrep. Unfortunately, experiments show that tries are space consuming, and ZGrep is too slow to be used in any applicative scenario. See for example I. H. Witten, A. Moffat, and T. C. Bell, Managing Gigabytes: Compressing and Indexing Documents and Images, Morgan Kaufmann Publishers, 1999.

The Permuterm index of Garfield (see E. Garfield, The Permuterm Subject Index: An Autobiographical Review, Journal of the American Society for Information Science, 27:288-291, 1976) has been used as a time-efficient and elegant solution to the Tolerant Retrieval problem. The general idea of the permuterm index is to take every string in a dictionary, sεD, append a special symbol $, and then consider all the cyclic rotations of s$. The dictionary of all rotated strings is called the permuterm dictionary, and may be indexed via any data structure that supports prefix-searches, e.g. the trie. Thus, a PREFIX-SUFFIX query may be solved by rotating the query string α*β$ so that the wild-card symbol appears at the end, namely β$α*. It then suffices to perform a PREFIX query for β$α over the permuterm dictionary. As a result, the Permuterm index allows to reduce any query of the Tolerant Retrieval problem on the dictionary D to a prefix query over its permuterm dictionary. Unfortunately the Permuterm index is space inefficient because it is considered to quadruple the dictionary size.

What is needed is a way to improve string processing and searching tasks for web search, information retrieval and data mining applications. Such a system and method should solve the tolerant retrieval problem in efficient query time and space.

### SUMMARY OF THE INVENTION

The present invention provides a system and method for string processing and searching using a compressed permuterm index. To do so, an index builder may be provided for generating a compressed permuterm index that may be formed from a collection of strings of a string dictionary, and a dictionary query engine may be provided for performing a search of the string dictionary using the compressed permuterm index. In an embodiment, the index builder constructs a unique string from a collection of strings of a dictionary sorted in lexicographic order and then builds a compressed permuterm index to support queries over the unique string. Once the compressed permuterm index is built for the string dictionary, many queries may be performed using the compressed permuterm index. In particular, the dictionary query engine may support queries to search the string dictionary by performing a backward search modified with a CyclicLF operation over the compressed permuterm index. These queries may be used to implement other queries including a membership query, a prefix query, a suffix query, a prefix-suffix query, a query for an exact or substring match, a rank query, a select query and so forth.

To build a compressed permuterm index for a string dictionary, a collection of strings representing the string dictionary may be received, and the collection of strings is sorted in lexicographic order. A unique string is then constructed by concatenating each string from the lexicographically sorted dictionary and inserting a special (smaller) symbol to delimit each of them. After a proper unique string is constructed from the collection of strings, a compressed permuterm index is then built to support queries over the unique string.

The present invention may support many applications for string processing and searching using the compressed permuterm index. For example, online search applications that may access text or documents from multiple sources may use the present invention to perform searches for patterns requested by complex queries that may include several wild-card symbols. Or the present invention may be used to perform searches for complex queries of a database that may require to prefix-match multiple fields of records in the database. Moreover, web searching applications, information retrieval applications and data mining applications may use the present invention for pattern matching (including exact, approximate, wild-card), ranking of a string in a sorted dictionary, selecting the i-th string from a sorted dictionary, and so forth. For any of these applications, string processing and searching tasks may accurately be performed for sophisticated queries without loss in time and space efficiency using the present invention. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for string processing and searching using a compressed permuterm index, in accordance with an aspect of the present invention;

FIG. 3 is a flowchart generally representing the steps undertaken in one embodiment for string processing and searching using a compressed permuterm index, in accordance with an aspect of the present invention;

FIG. 4 is a flowchart generally representing the steps undertaken in one embodiment for building a compressed permuterm index for a string dictionary, in accordance with an aspect of the present invention; and

FIG. 5 is a flowchart generally representing the steps undertaken in one embodiment for querying a string dictionary using a compressed permuterm index, in accordance with an aspect of the present invention.

### DETAILED DESCRIPTION

### Exemplary Operating Environment

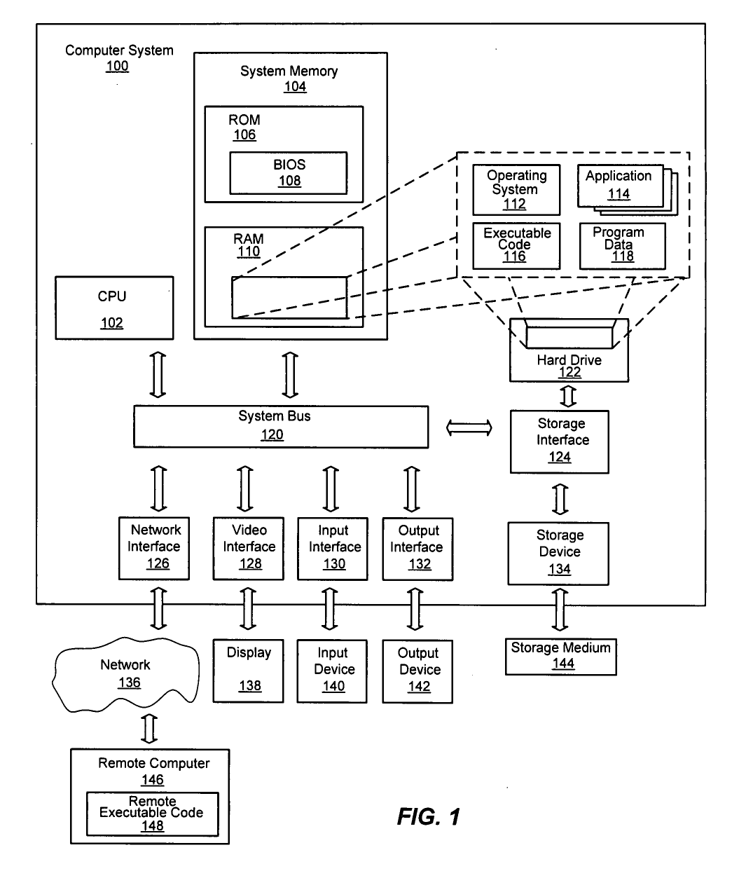

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### String Processing and Searching Using a Compressed Permuterm Index

The present invention is generally directed towards a system and method for string processing and searching using a compressed permuterm index. A permuterm index may mean herein a data structure used to index a dictionary of cyclic rotations of strings from a collection of strings. An index builder is provided for generating a compressed permuterm index that is formed from a collection of strings of a string dictionary, and a dictionary query engine is provided for performing a search of the string dictionary using the compressed permuterm index. Once the compressed permuterm index is built for the string dictionary, many queries may be performed using the compressed permuterm index. In particular, the dictionary query engine may support queries to search the string dictionary by performing a backward search modified with a CyclicLF operation over the compressed permuterm index. These queries may be used to implement other queries including a membership query, a prefix query, a suffix query, a prefix-suffix query, a query for an exact or substring match, a rank query, a select query and so forth.

As will be seen, the present invention may support many applications for string processing and searching. For example, online search applications may use the present invention to perform searches for patterns requested by complex queries that may include several wild-card symbols for pattern matching. As will be understood, the various block diagrams, flow charts and scenarios described herein are only examples, and there are many other scenarios to which the present invention will apply.

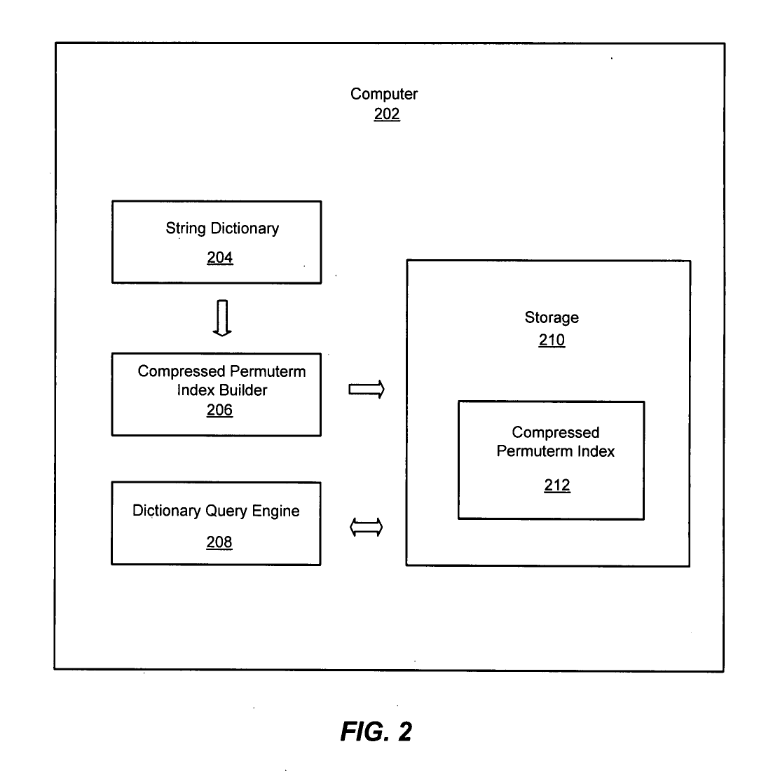

Turning to FIG. 2 of the drawings, there is shown a block diagram generally representing an exemplary architecture of system components for string processing and searching using a compressed permuterm index. Those skilled in the art will appreciate that the functionality implemented within the blocks illustrated in the diagram may be implemented as separate components or the functionality of several or all of the blocks may be implemented within a single component. For example, the functionality for the index builder 204 may be implemented as a component within the dictionary query engine 206. Or the functionality of the index builder 204 may be implemented on another computer as a separate component from the computer 202. Moreover, those skilled in the art will appreciate that the functionality implemented within the blocks illustrated in the diagram may be executed on a single computer or distributed across a plurality of computers for execution.

In various embodiments, a computer 202, such as computer system 100 of FIG. 1, may include a compressed permuterm index builder 206 and a dictionary query engine 208 operably coupled to storage 210. In general, the compressed permuterm index builder 206 and the dictionary query engine 208 may be any type of executable software code such as a kernel component, an application program, a linked library, an object with methods, and so forth. The storage 210 may be any type of computer-readable media and may store a compressed permuterm index 212 generated by the compressed permuterm index builder 206 that includes cyclic rotations of strings of a dictionary appended with a special (smaller) symbol.

The compressed permuterm index builder 206 constructs a unique string from a collection of strings of the dictionary sorted in lexicographic order and then builds a compressed permuterm index to support queries over the unique string. In general, the dictionary query engine 208 supports queries to search the string dictionary by performing a backward search modified with a CyclicLF operation over the compressed permuterm index. These queries may be used to implement other queries including a membership query, a prefix query, a suffix query, a prefix-suffix query, a query for an exact or substring match, a rank query, a select query and so forth.

There are many applications which may use the present invention for string processing and searching using a compressed permuterm index. For example, online search applications that may access text or documents from multiple sources may use the present invention to perform searches for patterns requested by complex queries that may include several wild-card symbols. Or the present invention may be used to perform searches for complex queries of a database that may require to prefix-match multiple fields of records in the database. Moreover, web searching applications, information retrieval applications and data mining applications may use the present invention for pattern matching (including exact, approximate, wild-card), ranking of a string in a sorted dictionary, selecting the i-th string from a sorted dictionary, and so forth. For any of these applications, string processing and searching tasks may accurately be performed for sophisticated queries without loss in time and space efficiency using the present invention.

Consider D to denote a sorted dictionary of m strings having total length n and drawn from an arbitrary alphabet Σ. D may be preprocessed in order to efficiently support the following WildCard(P) query operation: search for the strings in D which match the pattern Pε(Σ∪{*})⁺. Symbol * denotes the wild-card symbol, and matches any substring of Σ*. In principle, the pattern P might contain several occurrences of *; however, for practical reasons, it is common to restrict the attention to the following significant cases:
MEMBERSHIP query that determines whether a pattern PεΣ⁺ occurs in D; for the case of a membership query, P does not include wild-cards;
PREFIX query that determines all strings in D which are prefixed by string α; in this case, P=α* with a α=Σ⁺;
SUFFIX query that determines all strings in D which are suffixed by string β; in this case, P=*β with βεΣ⁺;
SUBSTRING query that determines all strings in D which have γ as a substring; in this case, P=*γ* with γεΣ⁺;
PREFIXSUFFIX query that determines all strings in D that are prefixed by α and suffixed by β; in this case, P=α*β with α,βεΣ⁺;
RANK(P) which computes the rank of string PεΣ⁺ within the (sorted) dictionary D; and
SELECT(i) which retrieves the i-th string of the (sorted) dictionary D.

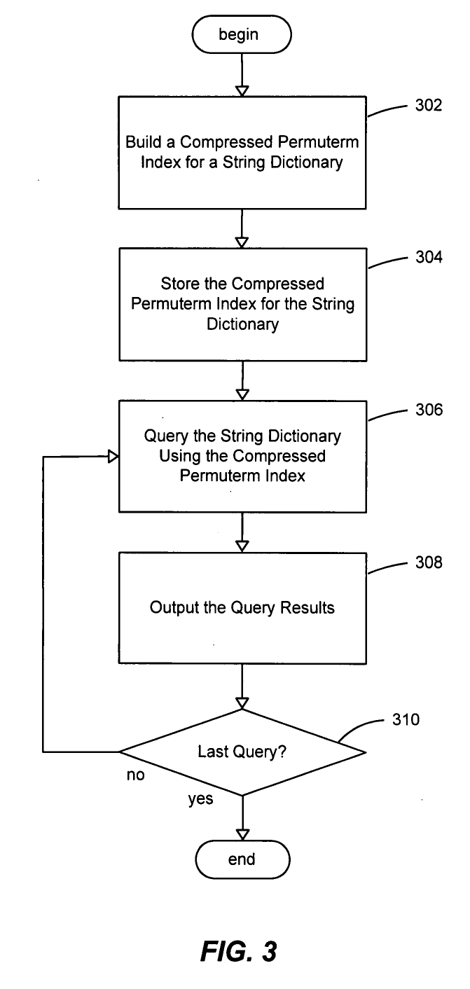

FIG. 3 presents a flowchart generally representing the steps undertaken in one embodiment for string processing and searching using a compressed permuterm index. At step 302, a compressed permuterm index is built for a string dictionary. In an embodiment, consider D={s₁, s₂ . . . , sₘ} to denote the lexicographically sorted dictionary of strings to be indexed. Then a unique string S_{D}=$s₁$s₂$ . . . $Sₘ₋₁$sₘ$# may be built by concatenating each string sᵢ from the lexicographically sorted dictionary and inserting a special symbol $ to delimit each string sᵢ in S_{D}. Assume $ (resp. #) to represent a symbol smaller (resp. larger) than any other symbol of Σ. A compressed permuterm index is then built for the unique string S_{D}.

The compressed permuterm index may then be stored for the string dictionary at step 304. The string dictionary may then be queried at step 306 using the compressed permuterm index and the results of processing the query may be output at step 308. In an embodiment, any query operation over the string dictionary may be implemented using the compressed permuterm index, including a MEMBERSHIP query, a PREFIX query, a SUFFIX query, a SUBSTRING query, a PREFIXSUFFIX query, a RANK query, a SELECT query, and so forth.

Once the compressed permuterm index is built for the string dictionary, many queries may be performed using the compressed permuterm index. Accordingly, after the string dictionary is queried at step 306 and the results of the query are output at step 308, it may be determined at step 310 whether the last query has been processed. If so, then query processing may be finished. Otherwise, processing may continue at step 306 and the string dictionary may be queried repeatedly at step 306 using the compressed permuterm index until the last query for the string dictionary has been processed.

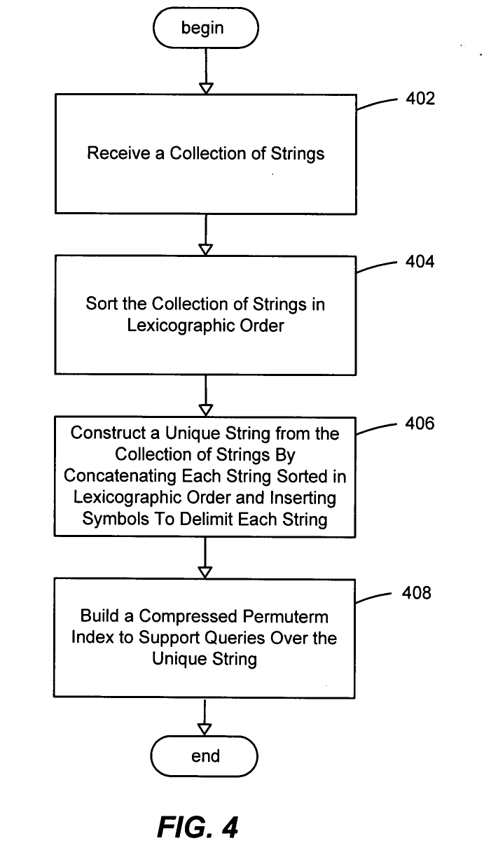

FIG. 4 presents a flowchart generally representing the steps undertaken in one embodiment for building a compressed permuterm index for a string dictionary. At step 402, a collection of strings may be received. The collection of strings may represent a corpus such as a dictionary of strings. At step 404, the collection of strings is sorted in lexicographic order. In an embodiment, D may represent a sorted dictionary of m strings having total length n and drawn from an arbitrary alphabet S. A unique string is then constructed at step 406 from the collection of strings by concatenating each string sorted in lexicographic order and inserting special (smaller) symbols to delimit each individual string used to construct the unique string. In an embodiment, such a unique string S_{D}=$s₁$s₂$ . . . $Sₘ₋₁$sₘ$# is built by concatenating each string sᵢ from the lexicographically sorted dictionary and inserting a special symbol $ to delimit each string sᵢ in S_{D}. The special symbol $ (resp. #) represents a symbol smaller (resp. larger) than any other symbol of Σ.

After a proper unique string is constructed at step 406 from the collection of strings, a compressed permuterm index is then built at step 408 to support queries over the unique string. In an embodiment, the Burrows-Wheeler Transform (BWT), known to those skilled in the art, may be applied by computing L=bwt(S_{D}) to transform the unique string S_{D} into a new string L that is typically easier to compress. See, for example, M. Burrows and D. Wheeler, A Block Sorting Lossless Data Compression Algorithm, TR n. 124, Digital Equipment Corporation, 1994. In general, the BWT of S_{D}, hereafter denoted by bwt(S_{D}), includes three basic steps:

1. append at the end of S_{D} a special symbol & smaller than any other symbol of Σ;

2. form a conceptual matrix M(S_{D}) whose rows are the cyclic rotations of string S_{D}& in lexicographic order; and

3. construct the string L by taking the last column of the sorted matrix M(S_{D}).

Every column of M(S_{D}), hence also the transformed string L, is a permutation of S_{D}&. In particular the first column of M(S_{D}), call it F, is obtained by lexicographically sorting the symbols of S_{D}& (or, equally, the symbols of L). Note that sorting the rows of M(S_{D}) results in essentially sorting the suffixes of S_{D} because of the presence of the special (smaller) symbol &. Consequently, there exists a strong relation between M(S_{D}) and a suffix array data structure built on S_{D}. This property is crucial for designing compressed indexes (see, for example, G. Navarro and V. Makinen, Compressed Full Text Indexes, ACM Computing Surveys, 39(1), 2007). Furthermore, symbols following the same substring (context) in S_{D} are grouped together in L, thus giving rise to clusters of nearly identical symbols. This property is the key for designing modern data compressors. (See, for example, G. Manzini, An Analysis of the Burrows-Wheeler Transform, Journal of the ACM, 48(3):407-430, 2001.)

Next, a compressed data structure is built to support Rank queries over the string L; this is the core of modern compressed full-text indexes. Compressed indexes may efficiently support the search of a fully specified pattern Q[1,q] as a substring of the indexed string S_{D}. The following two properties are crucial for the design of compressed indexes (see, for example, M. Burrows and D. Wheeler, A Block Sorting Lossless Data Compression Algorithm, TR n. 124, Digital Equipment Corporation, 1994):

1. Given the cyclic rotation of rows in M(S_{D}), L[i] precedes F[i] in the original string S_{D}; and

2. For any cεΣ, the 1-th occurrence of c in F and the 1-th occurrence of c in L correspond to the same character of string S_{D}.

The following function may be used to efficiently map characters in L to their corresponding characters in F (see, for instance, P. Ferragina and G. Manzini, Indexing Compressed Text, Journal of the ACM, 52(4):552-581, 2005):

LF(i)=C[L[i]]+rank_{L[i]}(L,i), where C[c] counts the number of characters smaller than c in the whole string L, and rank_{c}(L,i) counts the occurrences of c in the prefix L[1,i].

Array. C may be small and occupies O(|Σ|log n) bits. The implementation of function LF(·) is more sophisticated and well-know methods may be used by those skilled in the art to implement the function LF(·) and to design compressed data structures for supporting Rank over strings. See, for example, G. Navarro and V. Makinen, Compressed Full Text Indexes, ACM Computing Surveys, 39(1), 2007. See also J. Barbay, M. He, J. I. Munro, and S. Srinivasa Rao, Succinct Indexes for String, Binary Relations and Multi-labeled Trees, In Proceedings ACM-SIAM SODA, 2007. Given that L[i] precedes F[i] in the original string S_{D} and L[i] (which is equal to F[LF(i)]) is preceded by L[LF(i)], the iterated application of LF allows to move backward over the string S_{D}. Furthermore, Ferragina and Manzini (1995) also showed that compressed data structures for supporting Rank queries on the string L are enough to search for a pattern Q[1,q] as a substring of the indexed string S_{D}. The resulting search procedure is known in the art as a backward search and the following pseudo-code may represent the backward search algorithm:

Algorithm Backward Search(Q[1,q])

1. i = q, c = Q[q], First = C[c] + 1, Last = C[c + 1];
2. while ((First ≦ Last) and (i ≧ 2)) do
3. c = Q[i − 1];
4. First = C[c] + rank_{c}(L, First − 1) + 1;
5. Last = C[c] + rank_{c}(L, Last);
6. i = i − 1;
7. if (Last < First) then return “no rows prefixed by Q”
else return [First, Last].

The backward search algorithm works in q phases, each phase preserves the following invariant: at the end of the i-th phase, [First, Last] is the range of contiguous rows in M(S_{D}) which are prefixed by Q[i,q]. The backward search algorithm starts with i=q, so that First and Last are determined via the array C as indicated in the first line of the pseudo-code for Algorithm Backward Search. Thus, the pseudo-code for the Algorithm Backward Search maintains the invariant above for all phases, so at the end [First, Last] delimits the rows prefixed by Q (if any).

Although some queries are immediately implementable as substring searches over S_{D} by applying the backward search algorithm over standard compressed indexes built on S_{D}, the sophisticated PREFIXSUFFIX query needs a different approach because it requires to simultaneously match a prefix and a suffix of a dictionary string, which are possibly far apart from each other in S_{D}. In order to suitably support the PREFIXSUFFIX query, the backward search algorithm is modified by including a function, called jump2end, which implements a CyclicLF operation. As used herein, a CyclicLF operation means a leftward cyclic scan operation over a string in a dictionary. The basic concept is to modify the backward search algorithm with a leftward cyclic scan operation so that when the backward search algorithm reaches the beginning of some dictionary string, say sᵢ, then it “jumps” to its last character rather than continuing on the last character of its previous string in D, i.e. the last character of sᵢ₋₁. In an embodiment, the function jump2end(i) implements a CyclicLF operation using one line of code:

if 1≦i≦m then return (i+1) else return(i).

The following pseudo-code represents the backward search algorithm modified to include a CyclicLF operation by performing a “jump” to the last character of a dictionary string, sᵢ, upon reaching its beginning:

Algorithm Backward Permuterm Index Search(Q[1,q])

1. i = q, c = Q[q], First = C[c] + 1, Last = C[c + 1];
2. while ((First ≦ Last) and (i ≧ 2)) do
3. c = Q[i − 1];
4. First = jump2end(First); Last = jump2end(Last);
5. First = C[c] + rank_{c}(L, First − 1) + 1;
6. Last = C[c] + rank_{c}(L, Last);
7. i = i − 1;
8. if (Last < First) then return “no rows prefixed by Q”
else return [First, Last].

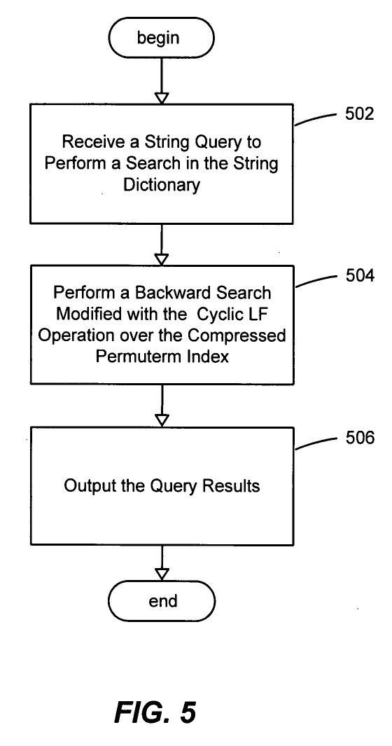

FIG. 5 presents a flowchart generally representing the steps undertaken in one embodiment for querying a string dictionary using a compressed permuterm index. At step 502, a string query to perform a search in the string dictionary may be received. At step 504, a backward search modified to include a cyclic LF operation is performed over the compressed permuterm index. For example, an implementation of the pseudo-code for Backward Permuterm Index Search algorithm described above may be used in an embodiment to perform a backward search modified to include a cyclic LF operation over a compressed permuterm index. And at step 506, the results of query processing may be output.

Any query operation may be implemented for querying the string dictionary using the algorithm for a backward search modified to include a cyclic LF operation over a compressed permuterm index, including a MEMBERSHIP query, a PREFIX query, a SUFFIX query, a SUBSTRING query, a PREFIXSUFFIX query, a RANK query, a SELECT query, and so forth. In an embodiment, these queries may be implemented as follows:
Membership query invokes Backward Permuterm Index Search ($P$) and then checks whether First<Last.

Prefix query invokes Backward Permuterm Index Search ($α) and returns the value Last-First+1 as the number of dictionary strings prefixed by α. These strings can be retrieved by applying Display string(i), for each iε[First,Last]. The following pseudo-code represents the algorithm Display string (i) which may be used to retrieve the string that includes the character F[i]

Algorithm Display string(i)

```
  1. // Go back to preceding $, let it be at row kᵢ
    while (F[i] ≠ $) do i = Back step(i);
  2. s = empty string;
  3. // Construct s = sₖᵢ, where symbol · represents the
concatenation between two strings;
    while(L[i] ≠ $) { s = L[i] ·s; i = Back step(i); };
  4. return(s).
```

The following pseudo-code represents the algorithm Back step (i) modified to support a leftward cyclic scan of a dictionary string:

Algorithm Back step(i)

1. Compute L[i];
2. return jump2end(C[L[i]] + rank_{L[i]}(L,i)).

Suffix query invokes Backward Permuterm Index Search (β$) and returns the value Last-First+1 as the number of dictionary strings suffixed by β. These strings can be retrieved by applying Display string(i), for each iε[First,Last].
Substring query invokes Backward Permuterm Index Search (γ) and returns the value Last-First+1 as the number of occurrences of γ as a substring of D's strings. Unfortunately, the optimal-time retrieval of these strings cannot be through the execution of Display string, as was the case for the queries above. A dictionary string s may now otherwise be retrieved multiple times if γ occurs many times as a substring of s. To circumvent this problem, a simple time-optimal retrieval may be implemented as follows. A bit vector V of size Last-First+1 is initialized to 0. The execution of Display string is thus modified so that V[j-First] is set to 1 when row jε[First,Last] is visited during its execution. In order to retrieve once all dictionary strings that contain γ, an implementation may scan through iE[First,Last] and invoke the modified Display string(i) only if V[i-First]=0.
PREFIXSUFFIX query invokes Backward Permuterm Index Search (β$α) and returns the value Last-First+1 as the number of dictionary strings which are prefixed by α and suffixed β. These strings can be retrieved by applying Display string(i), for each iε[First,Last].
Rank(P) invokes Backward Permuterm Index Search ($P$) and returns the value of First, if First<Last, otherwise it concludes that P∉D.
Select(i) invokes Display string(i) provided that 1≦i≦m.

The following pseudo-code represents the algorithm Display string (i) which may be used to retrieve the string that includes the character F[i].

Those skilled in the art will appreciate that the present invention may also be achieved by modifying the BWT in an alternate embodiment, instead of introducing the function jump2end and then modifying the backward search procedure. For example, the present invention may be achieved by modifying L=bwt(S_{D}) as follows: cyclically rotate the prefix L[1,m+1] of one single step (i.e. move L[1]=# to position L[m+1]).

Thus the present invention may improve both string processing and searching using a compressed permuterm index. Moreover, the searching method of the present invention may be applied in other indexing contexts. For example, given a database of records consisting of string pairs <nameᵢ,surnameᵢ>, there may be an interest in searching for all records in the database whose field name is prefixed by string α and field surname is prefixed by string β. This query can be implemented by invoking PREFIXSUFFIX(α*β^{R}) on a compressed permuterm index built on a dictionary of strings having the form ŝ₁=nameᵢ [symbol] (surnameᵢ)^{R}, where [symbol] is a special symbol not occurring in Σ and x^{R} denotes the reversal of string x. Given the small space occupancy of the compressed permuterm index, several compressed permuterm indexes could be built, specifically one per pair of fields on which there may be an interest to execute these types of queries.

As can be seen from the foregoing detailed description, the present invention provides an improved system and method for string processing and searching a string dictionary using a compressed permuterm index. A compressed permuterm index may first be built for a string dictionary, and then many queries may be performed for searching the string dictionary using the compressed permuterm index. Many applications may use the present invention for pattern matching (including exact, approximate, wild-card), ranking of a string in a sorted dictionary, selecting the i-th string from a sorted dictionary, and so forth. For any of these applications, string processing and searching tasks may accurately be performed for sophisticated queries without loss in time and space efficiency using the present invention. As a result, the system and method provide significant advantages and benefits needed in contemporary computing, and more particularly in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for string processing, comprising:
an index builder for constructing a compressed permuterm index to support queries over a unique string formed from a collection of strings of a string dictionary; and
a storage operably coupled to the index builder for storing the compressed index.

2. The system of claim 1 further comprising the string dictionary operably coupled to the index builder for providing the collection of strings.

3. The system of claim 1 further comprising a dictionary query engine operably coupled to the storage for processing queries of the string dictionary using the compressed index.

4. A computer-readable medium having computer-executable components comprising the system of claim 1.

5. A computer-implemented method for string processing, comprising:
receiving a plurality of strings;
building a compressed permuterm index from the plurality of strings; and
storing the compressed permuterm index in computer-readable storage.

6. The method of claim 5 further comprising querying the plurality of strings using the compressed permuterm index.

7. The method of claim 6 further comprising outputting the query results of querying the plurality of strings using the compressed permuterm index.

8. The method of claim 5 wherein building the compressed permuterm index from the plurality of strings comprises sorting the plurality of strings in lexicographic order.

9. The method of claim 5 wherein building the compressed permuterm index from the plurality of strings comprises constructing a unique string from the plurality of strings by concatenating each string of the plurality of strings sorted in lexicographic order and inserting a special symbol to delimit each string of the plurality of strings.

10. The method of claim 9 further comprising building the compressed permuterm index to support queries over the unique string.

11. The method of claim 6 wherein querying the plurality of strings using the compressed permuterm index comprises receiving a string query to perform a search in the plurality of strings.

12. The method of claim 11 further comprising performing a backward search of the compressed permuterm index using a leftward cyclic scan operation to process the string query.

13. The method of claim 12 wherein the string query comprises a prefix-suffix query.

14. The method of claim 12 wherein the string query comprises a rank query.

15. The method of claim 12 wherein the string query comprises a select query.

16. The computer-readable medium having computer-executable instructions for performing the method of claim 5.

17. A computer system for string processing, comprising:
means for querying a string dictionary using a compressed permuterm index;
means for performing a backward search of the compressed permuterm index using a cyclic LF operation to process a query; and
means for outputting the results of the query.

18. The computer system of claim 17 further comprising means for building the compressed permuterm index for the string dictionary.

19. The computer system of claim 17 wherein means for querying a string dictionary using a compressed permuterm index comprises means for performing pattern matching.

20. The computer system of claim 18 wherein means for building the compressed permuterm index for the string dictionary comprises means for constructing a unique string from a plurality of strings of the string dictionary by concatenating each string of the plurality of strings sorted in lexicographic order and inserting a special symbol to delimit each string of the plurality of strings.
